(19) United States
(12) Patent Application Publication
(10) Pub. No.: US 2024/0046466 A1
(43) Pub. Date: Feb. 8, 2024

(54) DETERMINING CHARACTERISTICS OF ADIPOSE TISSUE USING ARTIFICIAL NEURAL NETWORK

(71) Applicant: Siemens Healthcare GmbH, Erlangen (DE)

(72) Inventors: Michael SUEHLING, Erlangen (DE); Felix LADES, Erlangen (DE); Sasa GRBIC, Plainsboro, NJ (US); Bernhard GEIGER, Cranbury, NJ (US); Zhoubing XU, Plainsboro, NJ (US)

(73) Assignee: Siemens Healthcare GmbH, Erlangen (DE)

(21) Appl. No.: 18/362,204

(22) Filed: Jul. 31, 2023

(30) Foreign Application Priority Data
Aug. 1, 2022 (EP) 22188055.2

(51) Int. Cl. G06T 7/00; G06T 7/12

(52) U.S. Cl. CPC G06T 7/0012; G06T 7/12; G06T 2207/20084; G06T 2207/20081; G06T 2207/10081

(57) ABSTRACT

Techniques for determining at least one characteristic of adipose tissue included in an anatomical structure are provided. The at least one characteristic of the adipose tissue is determined based on one or more segmented CT images using a trained neural network. For example, the at least one characteristic of the adipose tissue may be determined by inputting the one or more segmented CT images into the trained neural network. The one or more segmented CT images are obtained by segmenting each one of one or more CT images depicting the anatomical structure including the adipose tissue to determine a contour of the adipose tissue.

### CROSS-REFERENCE TO RELATED APPLICATION(S)

The present application claims priority under 35 U.S.C. § 119 to European Patent Application No. 22188055.2, filed Aug. 1, 2022, the entire contents of which are incorporated herein by reference.

### FIELD

Various examples of the disclosure relate to determining at least one characteristic of adipose tissue comprised in an anatomical structure. Various examples of the disclosure specifically relate to determining, by a trained neural network, at least one characteristic of adipose tissue comprised in an anatomical structure based on one or more segmented CT images which depict a contour of the adipose tissue.

### BACKGROUND

Adipose tissue (AT) is commonly known as body fat. It is found all over the body. It can be found under the skin (subcutaneous fat), packed around internal organs (visceral fat), between muscles, within bone marrow and in breast tissue. AT is known to be an important risk factor for the development of the so-called metabolic syndrome, a whole cluster of disorders such as hypertension, cardiovascular disease, and diabetes. It also turned out that AT is an independent predictive factor of survival in COVID-19 patients. It has been shown that the risks associated with various diseases are not only related to the amount of AT, but also appear to be critically dependent on its segmental body distribution. For instance, people with a higher proportion of central fat deposits (visceral fat) are more likely to develop metabolic syndrome than those with a predominantly peripheral fat distribution (subcutaneous fat). Another example of segmental fat effects is the deposition of fat into skeletal muscles which can negatively affect sarcopenia, a loss in skeletal muscle mass and strength.

Beyond the segmental distribution and volume of AT in the body, the functional characterization of AT is also crucial for clinical decision-making. Adipose tissues may comprise white adipose tissue (WAT) and brown adipose tissue (BAT) exhibiting pro-inflammatory and anti-inflammatory characteristics, respectively. In the presence of an infectious or inflammatory process such as appendicitis or diverticulitis, lymphatic vessels within fat become leaky and the water content of adipose tissue increases. Such inflamed fat appears denser, assuming a smoky-grey appearance called fat stranding, e.g., in computed tomography (CT) images. Such fat stranding is often indicative of acute pathologies of adjacent organs.

In current clinical practice, simple anthropometric methods, such as waist-to-hip ratio, waist circumference or sagittal diameter are widely used to assess distribution and/or volume of adipose tissue. However, these methods cannot differentiate segmental fat compartments such as visceral and subcutaneous fat. Further, there exist semi-automatic approaches, based on CT or MR (Magnetic Resonance) measurements of adipose tissues, to extract such segmental fat compartments which are mostly restricted to 2D measurements such as the quantification of visceral and subcutaneous fat in a cross-section at the fourth lumbar vertebra level (L4). In addition, when determining fat stranding, pure visual identification of inflamed/stranded fat by human reading is usually used but such human reading approach is particularly challenging since BAT can be misinterpreted as infiltration of adipose tissue in an inflammatory process.

Accordingly, there is a need for advanced techniques which mitigate or overcome the above-identified drawbacks or restrictions. There is a need for advanced techniques of precise, reliable, and automatic assessment of AT, such as determining a type of the AT, a pattern of fat stranding of the AT, and activation or inactivation of the AT.

### SUMMARY

At least the above-discussed need is met by at least features of the independent claims. Features of the dependent claims define embodiments.

A computer-implemented method is provided. The method comprises obtaining one or more CT images depicting an anatomical structure comprising adipose tissue. The method further comprises segmenting each one of the one or more CT images such that a contour of the adipose tissue is determined. The method still further comprises determining, based on the one or more segmented CT images, at least one characteristic of the adipose tissue using a trained neural network.

A computing device comprising a processor and a memory is provided. Upon loading and executing program code from the memory, the processor is configured to perform a method. The method comprises obtaining one or more CT images depicting an anatomical structure comprising adipose tissue. The method further comprises segmenting each one of the one or more CT images such that a contour of the adipose tissue is determined. The method still further comprises determining, based on the one or more segmented CT images, at least one characteristic of the adipose tissue using a trained neural network.

A CT scanner comprising a computing device is provided. The computing device comprises a processor and a memory. Upon loading and executing program code from the memory, the processor is configured to perform a method. The method comprises obtaining one or more CT images depicting an anatomical structure comprising adipose tissue. The method further comprises segmenting each one of the one or more CT images such that a contour of the adipose tissue is determined. The method still further comprises determining, based on the one or more segmented CT images, at least one characteristic of the adipose tissue using a trained neural network.

A computer program product or a computer program or a computer-readable storage medium including program code is provided. The program code can be executed by at least one processor. Executing the program code causes the at least one processor to perform a method. The method comprises obtaining one or more CT images depicting an anatomical structure comprising adipose tissue. The method further comprises segmenting each one of the one or more CT images such that a contour of the adipose tissue is determined. The method still further comprises determining, based on the one or more segmented CT images, at least one characteristic of the adipose tissue using a trained neural network.

A computer-implemented method for performing a training of a neural network is provided. The neural network is used for determining at least one characteristic of adipose tissue. The method comprises obtaining one or more training CT images depicting an anatomical structure comprising the adipose tissue. The method further comprises segmenting each one of the one or more training CT images such that a contour of the adipose tissue is determined. The method still further comprises determining, based on the one or more segmented training CT images, at least one predicted characteristic of the adipose tissue using the neural network, and updating parameter values of the neural network based on a comparison between each of the at least one predicted characteristic and a corresponding reference characteristic of the adipose tissue.

A computing device comprising a processor and a memory is provided. Upon loading and executing program code from the memory, the processor is configured to perform a method for performing a training of a neural network. The neural network is used for determining at least one characteristic of adipose tissue. The method comprises obtaining one or more training CT images depicting an anatomical structure comprising the adipose tissue. The method further comprises segmenting each one of the one or more training CT images such that a contour of the adipose tissue is determined. The method still further comprises determining, based on the one or more segmented training CT images, at least one predicted characteristic of the adipose tissue using the neural network, and updating parameter values of the neural network based on a comparison between each of the at least one predicted characteristic and a corresponding reference characteristic of the adipose tissue.

A CT scanner comprising a computing device is provided. The computing device comprises a processor and a memory. Upon loading and executing program code from the memory, the processor is configured to perform a method for performing a training of a neural network. The neural network is used for determining at least one characteristic of adipose tissue. The method comprises obtaining one or more training CT images depicting an anatomical structure comprising the adipose tissue. The method further comprises segmenting each one of the one or more training CT images such that a contour of the adipose tissue is determined. The method still further comprises determining, based on the one or more segmented training CT images, at least one predicted characteristic of the adipose tissue using the neural network, and updating parameter values of the neural network based on a comparison between each of the at least one predicted characteristic and a corresponding reference characteristic of the adipose tissue.

A computer program product or a computer program or a computer-readable storage medium including program code is provided. The program code can be executed by at least one processor. Executing the program code causes the at least one processor to perform a method for performing a training of a neural network. The neural network is used for determining at least one characteristic of adipose tissue. The method comprises obtaining one or more training CT images depicting an anatomical structure comprising the adipose tissue. The method further comprises segmenting each one of the one or more training CT images such that a contour of the adipose tissue is determined. The method still further comprises determining, based on the one or more segmented training CT images, at least one predicted characteristic of the adipose tissue using the neural network, and updating parameter values of the neural network based on a comparison between each of the at least one predicted characteristic and a corresponding reference characteristic of the adipose tissue.

It is to be understood that the features mentioned above and those yet to be explained below may be used not only in the respective combinations indicated, but also in other combinations or in isolation without departing from the scope of the present invention.

### BRIEF DESCRIPTION OF THE DRAWINGS

FIG. 1 schematically illustrates an exemplary geometry of a CT scanner.

FIG. 2 schematically illustrates an exemplary segmented CT image according to various examples.

FIG. 3 schematically illustrates a further exemplary segmented CT image according to various examples.

FIG. 4 is a flowchart of a method according to various examples.

FIG. 5 schematically illustrates an exemplary neural network according to various examples.

FIG. 6 is a flowchart of a method according to various examples.

FIG. 7 is a block diagram of a device according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the present invention will be described in detail with reference to the accompanying drawings. It is to be understood that the following description of embodiments is not to be taken in a limiting sense. The scope of the present invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various techniques disclosed herein generally relate to determining at least one characteristic of adipose tissue comprised in an anatomical structure. The at least one characteristic of the adipose tissue is determined based on one or more segmented CT images using a trained neural network. For example, the at least one characteristic of the adipose tissue may be determined by feeding the one or more segmented CT images into the trained neural network. The one or more segmented CT images are obtained by segmenting each one of one or more CT images depicting the anatomical structure comprising the adipose tissue such that a contour of the adipose tissue is determined.

For example, it would be possible to determine a classification of at least one characteristic. Here, a discrete set of predefined classes is available and the result is a pointer to one of these predefined classes. For example, the at least one characteristic may comprise a type of the adipose tissue, i.e., an adipocyte type. Adipocyte types may be described by color hues. Adipose tissue has historically been classified into two types, white adipose tissue (WAT) and brown adipose tissue (BAT), which are visibly distinguishable based on tissue color. According to recent studying, the type of the adipose tissue may further comprise two additional adipocyte hues—beige and pink.

In other examples, it would be possible to determine a pattern of fat stranding of the adipose tissue. For example, abdominal fat stranding can produce various appearances in CT images. Whereas mild inflammation may cause a subtle hazy increased attenuation of the fat (ground-glass-like pattern), increasing severity of the inflammation can produce a reticular pattern, with more well-defined linear areas of increased attenuation. A reticulonodular appearance can also be observed frequently in association with neoplastic disease. See: non-patent literature—Thornton, Eavan, et al. “Patterns of fat stranding.” AJR-American Journal of Roentgenology 197.1 (2011): W1.

In further examples, it would be possible to determine activation or inactivation of the adipose tissue, in particular, activation or inactivation of BAT. BAT not only dissipates energy but also has a potential capacity to counteract obesity and related metabolic disorders (e.g., insulin resistance and dyslipidemia). BAT is a special type of body fat that is activated when the body surrounding gets cold. The identification and characterization of BAT, activated BAT, and WAT are therefore highly valuable, e.g., for therapeutic targeting. Therefore, it would be helpful to determine not only the volume of BAT but also activated BAT.

As a general rule, the one or more CT images may depict either a 2-D or 3-D anatomical structure of a patient. For example, the one or more CT images may depict a heart, a liver, a whole abdomen, or a part thereof, e.g., a slice of the heart, of the liver, or of the whole abdomen.

As a further general rule, the one or more CT images may be acquired by a conventional (or single-energy) CT scanner which uses a single polychromatic X-ray beam (ranging from 70 to 140 kVp (kilovoltage peak) with a standard of 120 kVp) emitted from a single source and received by a single detector. Alternatively, the one or more CT images may be acquired by a spectral CT scanner which can perform “color” x-ray detection. Such a spectral CT scanner may be a dual-energy CT scanner or a multi-energy CT scanner (See: non-patent literature—McCollough, Cynthia H., et al. “Dual—and multi-energy CT: principles, technical approaches, and clinical applications.” Radiology 276.3 (2015): 637.).

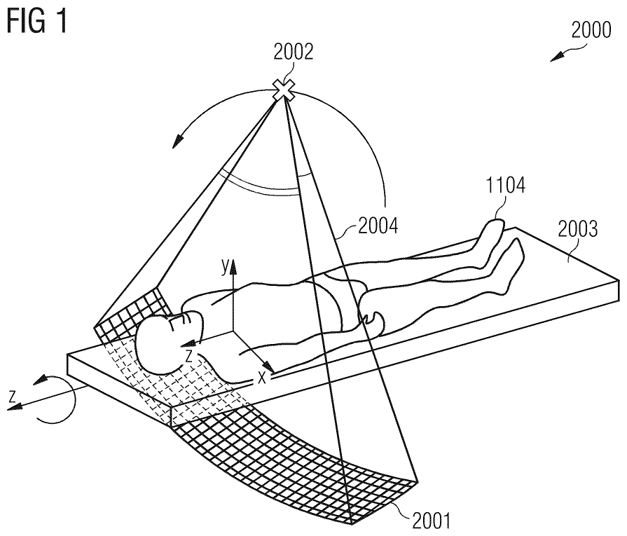

FIG. 1 schematically illustrates an exemplary geometry of a CT scanner 2000, i.e., a conventional CT scanner. The CT scanner 2000 comprises an x-ray tube 2002, a detector array 2001, a patient table 2003. The x-ray tube 2002 may be a cone-beam x-ray tube emitting an x-ray beam 2004 divergent in and covering an appreciable extent in the longitudinal (z) direction. The detector array 2001 may be a curved detector array having multiple rows of detectors. Both the x-ray tube 2002 and the detector array 2001 may be mounted on a C-arm, U-arm, or O-arm gantry depending on clinical applications ranging from image-guided interventions to diagnostic specialties. The CT scanner 2000 may operate with the patient 1104 stationary on the patient table 2003, and the x-ray tube 2002 together with the detector array 2001 rotate once to acquire a volumetric image. Alternatively or optionally, the CT scanner 2000 may operate using helical acquisition—with exquisitely engineered patient table 2003 for longitudinal (z-direction) translation of the patient 1104 during the scan.

According to various examples, to acquire spectral imaging data, the x-ray tube 2002 may be controlled to perform fast tube potential switching to allow alternate projection measurements to be acquired at low and high tube potentials. Alternatively, the x-ray tube 2002 may emit a single high tube potential beam and the detector array 2001 may comprise layered or “sandwich” scintillation detectors. The low-energy data are collected from the front or innermost detector layer and the high-energy data are collected from the back or outermost detector layer. Alternatively, the x-ray tube 2002 may comprise two or more independent x-ray sources and the detector array 2001 may comprise two or more independent data acquisition systems. X-ray emitted by each one of the two or more independent x-ray sources is detected by a corresponding one of the two or more independent data acquisition systems. Alternatively, the detector array 2001 may comprise photon-counting detectors. Such detectors are capable of counting discrete photon interactions. Based on the choice of energy thresholds and the associated energy of each photon, counts are placed into specific energy threshold data sets. Data associated with specific energy windows are created by subtracting different energy threshold data.

As a general rule, the CT scanner 2000 may comprise a computing device (not shown in FIG. 1) embedded in or connected with the CT scanner 2000. The computing device may comprise at least one processor, at least one memory, and at least one input/output (I/O) interface. The at least one processor is configured to load program code from the at least one memory and execute the program code. Upon executing the program code, the at least one processor may control the CT scanner 2000 to acquire CT imaging data, to process the acquired CT imaging data, e.g., filtering, motion correction, reconstruction and so on.

The CT scanner 2000 may be connectable to a database (not shown in FIG. 1), such as a picture archiving and communication system (PACS) located within a local network of a hospital, for storing acquired CT imaging data, and/or reconstructed CT images.

According to this disclosure, after acquiring the CT images depicting an anatomical structure comprising adipose tissue, one or more of the CT images may be applied to a segmentation algorithm known to the skilled person to determine one or more segmented CT images, in which a contour of the adipose tissue is determined. Then, the one or more segmented CT images are applied to a trained artificial neural network (also referred to as a neural network) to determine at least one characteristic of the adipose tissue.

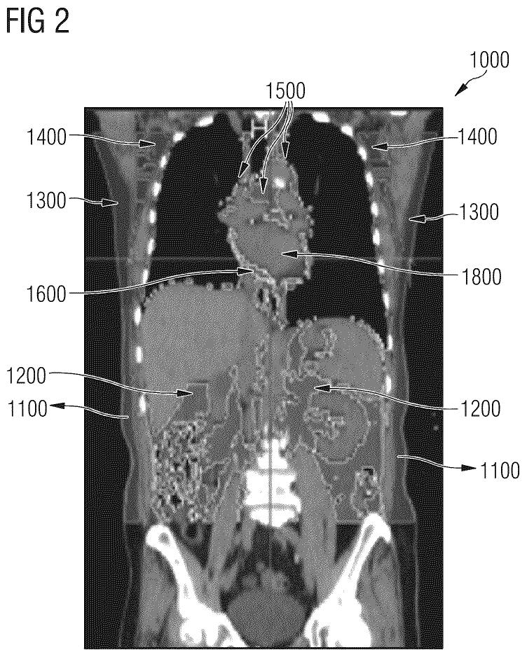

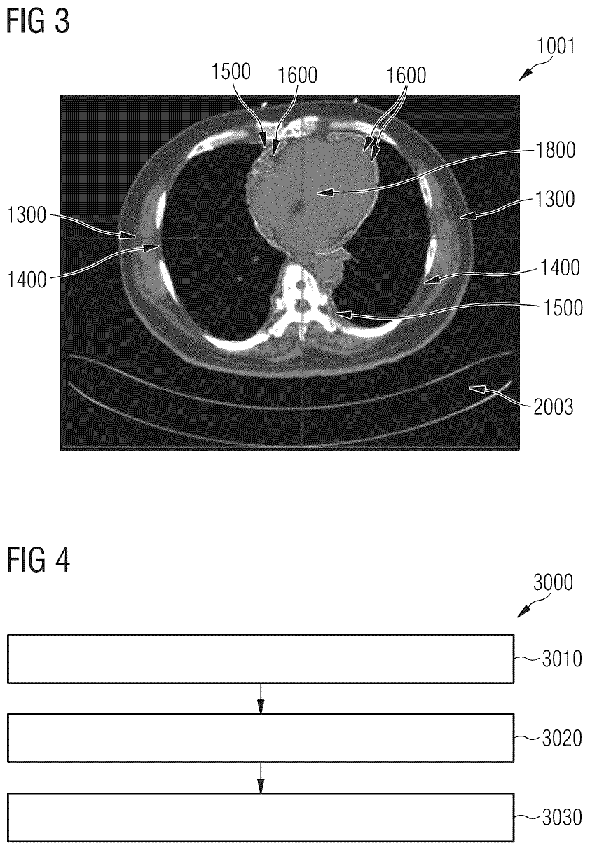

FIG. 2 schematically illustrates an exemplary segmented CT image 1000 according to various examples. The segmented CT image 1000 is a slice of CT image depicting anatomical structure comprising adipose tissue in the x-z plane of FIG. 1, i.e., the abdomen of the patient 1104. In addition, FIG. 3 schematically illustrates a further exemplary segmented CT image 1001 according to various examples. The segmented CT image 1001 is a slice of CT image depicting anatomical structure comprising adipose tissue in the x-y plane of FIG. 1, i.e., the abdomen of the patient 1104. In either FIG. 2 or FIG. 3, the adipose tissue may comprise abdominal subcutaneous fat 1100 (not shown in FIG. 3), abdominal visceral fat 1200 (not shown in FIG. 3), thoracic subcutaneous fat 1300, thoracic extrapericardial fat 1400, mediastinal fat 1500, and epicardial fat 1600. Both the mediastinal fat 1500 and epicardial fat 1600 are located close to a heart 1800.

Hereinafter, either the segmented CT image 1000 of FIG. 2 or the segmented CT image 1001 of FIG. 3 will be used as an example of the anatomical structure comprising adipose tissue to describe various techniques of this disclosure.

FIG. 4 is a flowchart of a method 3000 according to various examples. The method 3000 pertains to determining at least one characteristic of adipose tissue comprised in an anatomical structure, e.g., the abdomen of the patient 1104. The at least one characteristic of the adipose tissue is determined based on one or more segmented CT images, e.g., the segmented CT images 1000 or 1001, using a trained neural network. For example, the at least one characteristic of the adipose tissue may be determined by feeding the one or more segmented CT images into the trained neural network. The one or more segmented CT images are obtained by segmenting each one of one or more CT images depicting the anatomical structure comprising the adipose tissue such that a contour of the adipose tissue is determined.

The method 3000 may be executed by a computing device comprising at least one processor upon loading program code. The computing device may be embedded in or connected with the CT scanner 2000. Details of the method 3000 are described below.

Block 3010: obtaining one or more CT images depicting an anatomical structure comprising adipose tissue. The one or more CT images could be loaded from a PACS or obtained directly from a CT scanner, such as the CT scanner 2000 of FIG. 1. Block 3010 could include controlling a CT scanner to acquire the CT images. The CT images could be loaded from a memory. Alternatively, the CT images may be received directly from a CT scanner during a scan to perform a real-time determination of the at least one characteristic of the adipose tissue.

Optionally or alternatively, the one or more CT images may be obtained based on spectral imaging data associated with the anatomical structure. For example, the spectral imaging data may be acquired using a spectral CT scanner.

Block 3020: segmenting each one of the one or more CT images such that a contour of the adipose tissue is determined. Each one of the one or more CT images may be segmented using a segmentation algorithm known to the skilled person. For example, adipose tissue associated with the heart 1800 of the patient 1104 may be segmented using techniques disclosed in a non-patent literature—Militello, Carmelo, et al. “A semi-automatic approach for epicardial adipose tissue segmentation and quantification on cardiac CT scans.” Computers in biology and medicine 114 (2019): 103424.

According to various examples, when the one or more CT images depict multiple anatomical structures, the anatomical structure may be detected using techniques as disclosed in a non-patent literature—Ghesu, Florin-Cristian, et al. “Multi-scale deep reinforcement learning for real-time 3D-landmark detection in CT scans.” IEEE transactions on pattern analysis and machine intelligence 41.1 (2017): 176-189. Then, the anatomical structure may be segmented using techniques as disclosed in a non-patent literature—Yang, Dong, et al. “Automatic liver segmentation using an adversarial image-to-image network.” International conference on medical image computing and computer-assisted intervention. Springer, Cham, 2017. See: Kratzke, Lisa, Nilesh Mistry, Christian Mohler, Annie Bruder, Siemens Healthineers, Allison Mtiller, Thomas Weissmann, Sina Mansoorian, and Florian Putz. “DirectORGANS 2.0.” Optionally or additionally, based on the identified anatomical structures, e.g., body, heart, ribs, bowel bag, lungs, and/or aorta, adipose tissue (compartments) 1100, 1200, 1300, 1400, 1500, and/or 1600 could be identified by thresholding, e.g., the interval of −150 HU (Hounsfield unit) to 0 HU.

According to various example, the segmented CT image may comprise at least one of abdominal subcutaneous and/or visceral fat, thoracal subcutaneous, mediastinal and/or pericardial fat, skeletal muscle compartments for intra—and/or peri-muscular adipose tissue, vascular structures for peri-vascular adipose tissue.

Block 3030: determining, based on the one or more segmented CT images, at least one characteristic of the adipose tissue using a trained neural network.

According to various examples, the at least one characteristic of the adipose tissue comprises a type of the adipose tissue, a pattern of fat stranding of the adipose tissue, activation or inactivation of the adipose tissue. For example, the trained neural network may output a single image for each one of the at least one characteristic of the adipose tissue. For example, one image may merely comprise BAT or WAT. Another image may merely comprise fat stranding with a certain pattern. The other image may merely comprise activated BAT. Additionally or alternatively, further images merely depicting a certain characteristic of the adipose tissue may be also determined.

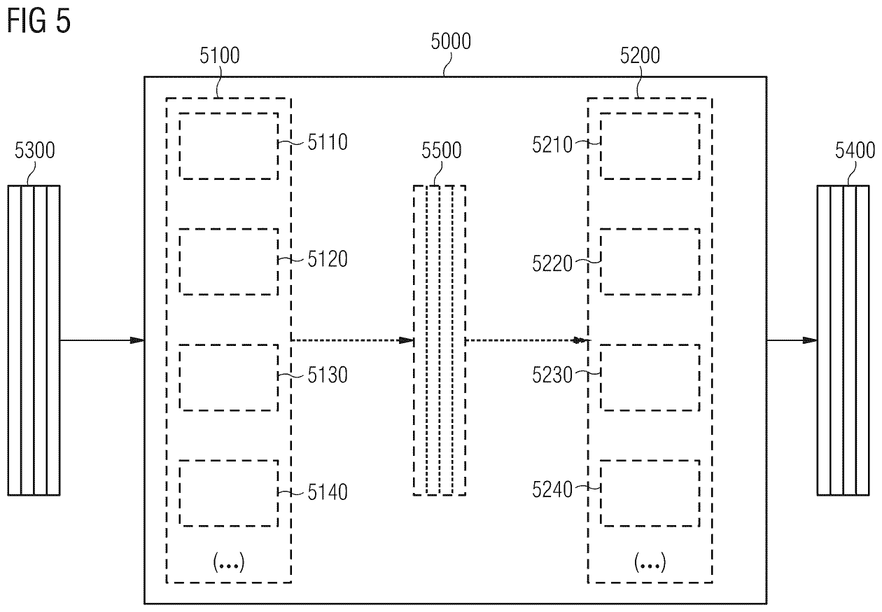

According to various example, the (trained) neural network may have an encoder-decoder structure, such as U-net as disclosed in a non-patent literature—Ronneberger, Olaf, Philipp Fischer, and Thomas Brox. “U-net: Convolutional networks for biomedical image segmentation.” International Conference on Medical image computing and computer-assisted intervention. Springer, Cham, 2015. For example, the neural network may be implemented according to the neural network 5000 of FIG. 5.

FIG. 5 schematically illustrates an exemplary neural network 5000 according to various examples. The neural network 5000 may comprise an encoder part 5100 and a decoder part 5200. The encoder part 5100 may be configured to generate features 5500 associated with one or more segmented CT images 5300, and the decoder part 5200 may be configured to generate/determine at least one characteristic 5400 of the adipose tissue based on the features 5500.

When the one or more CT images obtained at block 3010 are acquired based on spectral imaging data associated with the anatomical structure, the method 3000 may further comprises determining, based on the spectral imaging data, at least one material-decomposed image, and the determining of the at least one characteristic of the adipose tissue is further based on the at least one material-decomposed image.

According to various examples, the at least one material-decomposed image may comprise at least one of a non-contrast fat image, a non-contrast water image, a contrast-enhanced iron image, and a contrast-enhanced iodine image. Details with respect to different material-decomposed images will be explained according to the following two scenarios.

Scenario 1: non-contrast CT images

In case, non-contrast CT (NCCT) images are obtained at block 3010, the following material-decomposed images can be derived:

non-contrast fat image: a fat-water two-material decomposition can be used to estimate the overall fat concentrations within regions of interest. BAT has a significantly lower fat concentration than WAT which may be reflected also by the fat image.

non-contrast water image: this material-decomposed image could reflect that BAT has a higher water fraction than WAT. Increased water content may also indicate inflamed fat since microscopic lymphatic vessels within fat become leaky during inflammation.

Besides the non-contrast fat image and the non-contrast water image, also the original NCCT may serve as input to the trained neural network to also exploit changes in HU values and image texture patterns, e.g., for fat stranding regions. In addition, CT HU values of BAT may be significantly greater under activated conditions than under non-activated conditions.

Scenario 2: contrast-enhanced CT images

In case, contrast-enhanced CT (CECT) images are obtained at block 3010, the following material-decomposed images can be derived:

contrast-enhanced iron image: the iron image may reflect the increased iron concentration in BAT.

contrast-enhanced iodine image: the iodine image can be derived for example from three-material iodine, fat, and soft tissue decomposition. In particular, the iodine image may help to differentiate WAT from BAT that has a higher vascularization compared to WAT. In particular, the amount of increased perfusion/iodine uptake in activated BAT is associated with the degree of BAT activation. Furthermore, increased perfusion and iodine uptake are also observed in surrounding inflamed fat secondary to a primary inflammation (e.g., appendicitis).

Besides the contrast-enhanced iron image and the contrast-enhanced iodine image, also the original CECT may serves as input to the trained neural network to also exploit changes in the HU values and image texture patterns due to characteristic contrast dynamics of different adipose tissue types.

When at least one material-decomposed image is fed into the trained neural network, e.g., 5000, together with the one or more segmented CT images, the encoder part 5100 of the trained neural network 5000 may comprise multiple encoders 5110, 5120, 5130, and 5140, and at least one decoder, i.e., the decoder part 5200. The determining of the at least one characteristic of the adipose tissue using the trained neural network 5000 may comprise: feeding the one or more segmented CT images and each one of the at least one material-decomposed image to a respective encoder of the multiple encoders 5110, 5120, 5130, and 5140; obtaining respective features associated with the adipose tissue from each of the multiple encoders; concatenating the obtained respective features; and, determining, based on the concatenated features 5500, the at least one characteristic 5400 of the adipose tissue by the at least one decoder.

Optionally or additionally, the decoder part 5200 the trained neural network 5000 may comprise multiple decoders 5210, 5220, 5230, as well as 5240, and each one of the multiple decoders 5210, 5220, 5230, as well as 5240 outputs a distinct characteristic of the adipose tissue. For example, the multiple decoders 5210, 5220, 5230, as well as 5240 may respectively output images merely comprising BAT, WAT, fat stranding, and activated BAT.

Optionally or additionally, the method 3000 may further comprises determining a reference region in the anatomical structure and normalizing a contrast of each one of the one or more segmented CT images based on the reference region. The determining of the at least one characteristic of the adipose tissue is based on the one or more normalized segmented CT images. For example, vascular structures such as the aorta may serve as a reference to standardize/normalize the one or more segmented CT images with respect to, e.g., subject-specific contrast bolus dynamics or variations in kV (kilovoltage) settings during CT acquisition.

By determining at least one characteristic of adipose tissue comprised in an anatomical structure by processing one or more segmented CT images using a trained neural network, adipose tissue can be fully automatically, precisely, and reliably identified, quantified, and characterized (e.g. brown vs. white adipose tissue, fat stranding) from CT images. By further normalizing a contrast of each one of the one or more segmented CT images based on a reference region, inter-subject variations, e.g., with respect to subject-specific contrast bolus dynamics, could be minimized, and thereby the techniques disclosed herein could be standardized and determine more precise and more reliable results. By still further taking advantage of spectral CT, the at least one characteristic of the adipose tissue is determined by taking at least one material-decomposed image into account, and thereby comprehensive adipose tissue characterization can be performed. Further, depending on the scan protocol and resulting CT data (e.g., NCCT or CECT), the input of the neural network may vary. Each input channel would independently go through an encoder to extract relevant context for adipose characterization. The extracted features from each input channel would be concatenated and then go through a decoder to generate the outcome of tissue classification/characterization. Given the independent feature extraction, the entire workflow can still be functional even if some input channels may not be available (e.g., NCCT or CECT) during both training and deployment.

According to various example, before applying the trained neural network 5000 to the one or more segmented CT images to determine at least one characteristic of adipose tissue. The neural network 5000 may be trained by updating trainable parameters and hyperparameters of the neural network 5000.

According to the disclosure, various training methods of neural networks may be applied to train the neural network 5000, such as supervised learning, unsupervised learning, semi-supervised learning, reinforce learning and etc.

In general, the neural network 5000 may be executed by a node of an edge computing system, or by a cloud computing system, or by the CT scanner 2000 of FIG. 1, for example by a computing device embedded into or connected to the CT scanner 2000.

According to the disclosure, the encoder part 5100 and the decoder part 5200 of the neural network 5000 may be trained separately using different sets of training data based on supervised learning techniques. Each training process can include determining a loss value based on a comparison between a prediction of the respective one of the encoder part 5100 and the decoder part 5200 and a ground truth. A loss function can provide the loss value by performing the comparison. Based on the loss value, it is then possible to adjust the weights of the encoder part 5100 and the decoder part 5200, respectively. Here, an optimization algorithm, e.g., gradient descent, can be employed. Backpropagation can be an alternative.

On the other hand, the encoder part 5100 and the decoder part 5200 of the neural network 5000 may be trained jointly, i.e., the two parts may be regarded as a whole, and parameter values of both parts are updated together by using, for example, backpropagation in a joint optimization process based on a common loss value. This corresponds to end-to-end training.

According to various examples, each of the encoder part 5100 and the decoder part 5200 of the neural network 5000 may be trained using different training techniques, respectively. For example, the encoder part 5100 may be trained by using supervised learning, and the decoder part 5200 may be trained by using unsupervised learning.

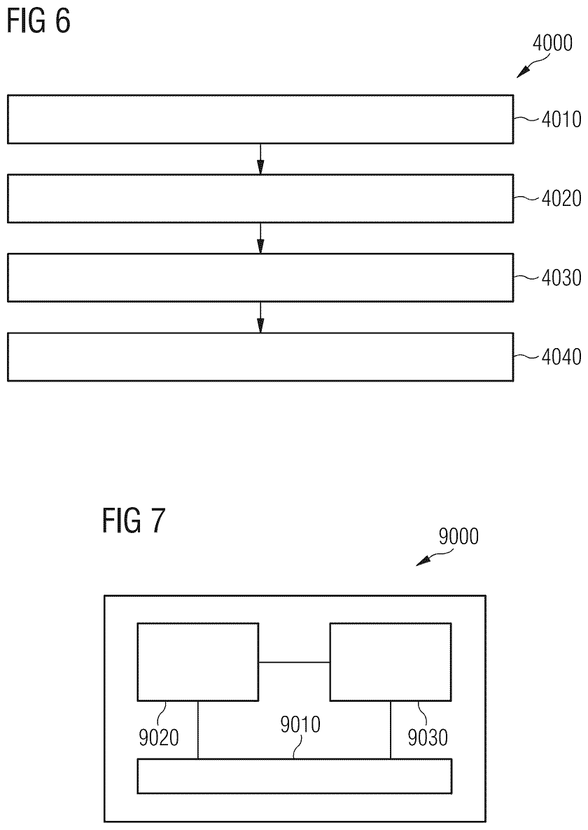

FIG. 6 is a flowchart of a method 4000 according to various examples. The method 4000 pertains to performing a training of the neural network 5000 of FIG. 5. The method 4000 utilizes supervised learning. Details of the method 4000 are described below.

Block 4010: obtaining one or more training CT images depicting an anatomical structure comprising the adipose tissue.

For example, the one or more training CT images may be obtained from a database, such as the PACS.

Block 4020: segmenting each one of the one or more training CT images such that a contour of the adipose tissue is determined.

The same techniques described at block 3020 of FIG. 4 could be applied to at block 4020.

Block 4030: determining, based on the one or more segmented training CT images, at least one predicted characteristic of the adipose tissue using the neural network 5000.

Block 4040: updating parameter values of the neural network 5000 based on a comparison between each of the at least one predicted characteristic and a corresponding reference characteristic of the adipose tissue.

According to various examples, each of the reference characteristics of the adipose tissue is determined based on positron emission tomography, PET, images depicting the anatomical structure comprising the adipose tissue, and/or magnetic resonance, MR, images depicting the anatomical structure comprising the adipose tissue. Since adipose tissues are highly metabolically active, fluoroDeoxyGlucose (FDG) PET/CT data may be well suited as a reference. For example, the standardized uptake value uptake of BAT is significantly higher compared to WAT. Controlled activation of BAT via, e.g., a temperature-controlled room or pharmacological stimulation that varies across follow-up PET/CT scans of a subject, allows to generate reference values for different BAT activation levels of the same subject. Besides FDG PET/CT, Magnetic Resonance Imaging (MRI) can assess brown adipose tissue (BAT) structure and function serving as another possible reference for training. Regarding the reference for inflamed/stranded fat, such regions can be annotated by expert Radiologists based on, e.g., confirmed primary organ inflammations.

According to various examples, the PET images can be obtained together with the training CT images using a PET/CT scanner.

Similar to the method 3000 of FIG. 4, the method 4000 may further comprise determining a reference region in the anatomical structure, and normalizing a contrast of each one of the one or more segmented training CT images based on the reference region. The determining of the at least one predicted characteristic of the adipose tissue is based on the one or more normalized segmented training CT images.

According to various examples, the one or more training CT images may be obtained based on spectral imaging data associated with the anatomical structure. For example, the spectral imaging data may be acquired using a spectral CT scanner.

Optionally or additionally, the method 4000 may further comprise determining, based on the spectral imaging data, at least one material-decomposed image and the determining of the at least one predicted characteristic of the adipose tissue may be further based on the at least one material-decomposed image.

According to various examples, the at least one material-decomposed image may comprise at least one of a non-contrast fat image, a non-contrast water image, a contrast-enhanced iron image, and a contrast-enhanced iodine image.

FIG. 7 is a block diagram of a computing device 9000 according to various examples. The computing device 9000 may comprise a processor 9020, a memory 9030, and an input/output interface 9010. The processor 9020 is configured to load program code from the memory 9030 and execute the program code. Upon executing the program code, the processor 9020 performs the method 3000 for determining at least one characteristic of adipose tissue comprised in an anatomical structure and/or the method 4000 for performing a training of the neural network 5000.

Referring to FIG. 1 again, the CT scanner 2000 may further comprise the computing device 9000 configured to perform the method 3000 and/or the method 4000. The computing device 9000 may be embedded in or connected with the CT scanner 2000, and thereby the CT scanner 100 may be also configured to perform the method 3000 and/or the method 4000.

Summarizing, techniques have been described that facilitate fully automatic, precise, and reliable identification, quantification, and/or characterization of adipose tissue based on CT images. By further normalizing a contrast of each one of the one or more segmented CT images based on a reference region, inter-subject variations, e.g., with respect to subject-specific contrast bolus dynamics, could be minimized, and thereby the techniques disclosed herein could be standardized and determine more precise and more reliable results. By still further taking advantage of spectral CT, the at least one characteristic of the adipose tissue is determined by taking at least one material-decomposed image into account, and thereby comprehensive adipose tissue characterization can be performed. Further, depending on the scan protocol and resulting CT data (e.g., NCCT or CECT), the input of the neural network may vary. Each input channel would independently go through an encoder to extract relevant context for adipose characterization. The extracted features from each input channel would be concatenated and then go through a decoder to generate the outcome of tissue classification/characterization. Given the independent feature extraction, the entire workflow can still be functional even if some input channels may not be available (e.g., NCCT or CECT) during both training and deployment.

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

For illustration, the disclosure is explained in detail based on 2-D CT images. The techniques disclosed herein can be also applied to 3-D CT images. For example, one or more CT images comprising multiple voxels may be processed by the techniques disclosed herein to determine at least one characteristic of adipose tissue comprised in a segment of the human body, e.g., a segment of the abdomen.

Further, the techniques disclosed herein can be also respectively applied to CT images depicting different slices or segments of a human body, and thereby at least one characteristic of adipose tissue of the whole body could be determined.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, Cif, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been shown and described with respect to certain example embodiments, equivalents and modifications will occur to others skilled in the art upon the reading and understanding of the specification. The present invention includes all such equivalents and modifications and is limited only by the scope of the appended claims.

What is claimed is:

1. A computer-implemented method, comprising:
obtaining one or more computed tomography images depicting an anatomical structure including adipose tissue;
segmenting each of the one or more computed tomography images to determine a contour of the adipose tissue; and
determining, based on the one or more segmented computed tomography images, at least one characteristic of the adipose tissue using a trained neural network.

2. The computer-implemented method of claim 1, further comprising:
determining a reference region in the anatomical structure;
normalizing a contrast of each of the one or more segmented computed tomography images based on the reference region; and wherein
said determining of the at least one characteristic of the adipose tissue is based on the one or more normalized segmented computed tomography images.

3. The computer-implemented method of claim 1, wherein the one or more computed tomography images are obtained based on spectral imaging data associated with the anatomical structure.

4. The computer-implemented method of claim 3, further comprising:
determining, based on the spectral imaging data, at least one material-decomposed image; wherein
said determining of the at least one characteristic of the adipose tissue is further based on the at least one material-decomposed image.

5. The computer-implemented method of claim 4, wherein the at least one material-decomposed image comprises at least one of a non-contrast fat image, a non-contrast water image, a contrast-enhanced iron image, or a contrast-enhanced iodine image.

6. The computer-implemented method of claim 4, wherein
the trained neural network includes multiple encoders and at least one decoder, and
said determining of the at least one characteristic of the adipose tissue using the trained neural network includes
inputting the one or more segmented computed tomography images and each of the at least one material-decomposed image to a respective encoder of the multiple encoders,
obtaining respective features associated with the adipose tissue from each of the multiple encoders,
concatenating the respective features, and
determining, based on the concatenated respective features, the at least one characteristic of the adipose tissue by the at least one decoder.

7. The computer-implemented method of claim 6, wherein the trained neural network comprises multiple decoders and each of the multiple decoders outputs a distinct characteristic of the adipose tissue.

8. The computer-implemented method of claim 1, wherein the at least one characteristic of the adipose tissue comprises a type of the adipose tissue, a pattern of fat stranding of the adipose tissue, activation or inactivation of the adipose tissue.

9. A computer-implemented method for training a neural network for determining at least one characteristic of adipose tissue, the computer-implemented method comprising:
obtaining one or more training computed tomography images depicting an anatomical structure including the adipose tissue;
segmenting each of the one or more training computed tomography images to determine a contour of the adipose tissue;
determining, based on the one or more segmented training computed tomography images, at least one predicted characteristic of the adipose tissue using the neural network; and
updating parameter values of the neural network based on a comparison between each of the at least one predicted characteristic and a corresponding reference characteristic of the adipose tissue.

10. The computer-implemented method of claim 9, wherein each reference characteristic of the adipose tissue is determined based on at least one of positron emission tomography images depicting the anatomical structure including the adipose tissue or magnetic resonance images depicting the anatomical structure including the adipose tissue.

11. The computer-implemented method of claim 9, further comprising:
determining a reference region in the anatomical structure;
normalizing a contrast of each of the one or more segmented training computed tomography images based on the reference region; and wherein
said determining of the at least one predicted characteristic of the adipose tissue is based on the one or more normalized segmented training computed tomography images.

12. The computer-implemented method of claim 9, wherein the one or more training computed tomography images are obtained based on spectral imaging data associated with the anatomical structure.

13. The computer-implemented method of claim 12, further comprising:
determining, based on the spectral imaging data, at least one material-decomposed image; and wherein
said determining of the at least one predicted characteristic of the adipose tissue is further based on the at least one material-decomposed image.

14. The computer-implemented method of claim 13, wherein the at least one material-decomposed image comprises at least one of a non-contrast fat image, a non-contrast water image, a contrast-enhanced iron image, or a contrast-enhanced iodine image.

15. A computing device comprising:
at least one processor; and
a memory storing computer-executable instructions that, when executed by the at least one processor, cause the computing device to perform the method of claim 1.

16. A computing device comprising:
at least one processor; and
a memory storing computer-executable instructions that, when executed by the at least one processor, cause the computing device to perform the method of claim 9.

17. The computer-implemented method of claim 2, wherein the one or more computed tomography images are obtained based on spectral imaging data associated with the anatomical structure.

18. The computer-implemented method of claim 5, wherein
the trained neural network comprises multiple encoders and at least one decoder, and
said determining of the at least one characteristic of the adipose tissue using the trained neural network includes
inputting the one or more segmented computed tomography images and each of the at least one material-decomposed image to a respective encoder of the multiple encoders,
obtaining respective features associated with the adipose tissue from each of the multiple encoders,
concatenating the respective features, and
determining, based on the concatenated respective features, the at least one characteristic of the adipose tissue by the at least one decoder.

19. The computer-implemented method of claim 10, further comprising:
determining a reference region in the anatomical structure;
normalizing a contrast of each of the one or more segmented training computed tomography images based on the reference region; and wherein
said determining of the at least one predicted characteristic of the adipose tissue is based on the one or more normalized segmented training computed tomography images.

20. The computer-implemented method of claim 19, wherein the one or more training computed tomography images are obtained based on spectral imaging data associated with the anatomical structure.
